(19) United States
(12) Patent Application Publication
(10) Pub. No.: US 2009/0145538 A1
(43) Pub. Date: Jun. 11, 2009

(54) MANUFACTURING METHOD OF VEHICLE MOLDED CEILING

(76) Inventors: Takashi Kojima, Aichi-ken (JP); Yoshiaki Kato, Aichi-ken (JP); Kazutoshi Somiya, Aichi-ken (JP); Ryoichi Kawabata, Aichi-ken (JP)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/989,413

(22) PCT Filed: Jul. 25, 2006
(86) PCT No.: PCT/JP2006/314674

§ 371 Date: Jan. 25, 2008

(30) Foreign Application Priority Data
Jul. 28, 2005 (JP) 2005-219493

(51) Int. Cl. B32B 37/00

(52) U.S. Cl. 156/245

(57) ABSTRACT

A process for producing a molded ceiling for a vehicle that, after molding of a molded ceiling, can allow a mill end to be easily separated from a skin material by a nonwoven fabric layer and can easily conduct edge treatment of a base material to improve productivity. In this process for producing a molded ceiling for a vehicle, a base material together with a skin material is set in a mold in which a molding face is formed in a required curved surface, followed by heating and pressing to bond the base material and the skin material to each other and thus to prepare a molded ceiling. A nonwoven fabric layer for facilitating the separation between the base material and the skin material even after molding is previously interposed between the base material and the skin material. A cut, which extends from the backside of the molded ceiling to the base material, is provided, and only the mill end of the base material is separated from the skin material by the nonwoven fabric layer, and an adhesive is coated onto a part from which the mill end of the skin material has been removed. The skin material is wound in and bonded to the edge of the base material to cover the edge with the skin material.

### TECHNICAL FIELD

The present invention relates to a manufacturing method of a vehicle molded ceiling, in which a rim or an edge, etc. of an opening of the vehicle molded ceiling undergoes covering treatment by a surface material.

### BACKGROUND ART

Generally, a vehicle molded ceiling is manufactured by setting a base material such as a fiber-based, cardboard-based, urethan-based, or olefin-foam-based material together with a surface material composed of a textile, which is referred to as a fabric, cloth, knit, or the like, in mold dies having molding surfaces formed to be required curved surfaces, and heating/pressurizing the same.

For example, when an opening for a sunroof is formed in the molded ceiling, an edge of the base material generated by the opening is covered so that it is not directly exposed to the interior side by winding a surface material around the edge. Similar covering treatment is performed also for a rim of the molded ceiling.

The below described Patent Documents 1 and 2 disclose manufacturing methods of covering edges of molded ceilings by surface materials.

Patent Document 1: Japanese Patent Application Laid-Open (kokai) No. H10-264734
Patent Document 2: Japanese Patent Application Laid-Open (kokai) No. H10-264735

### DISCLOSURE OF INVENTION

### Problems to be Solved by the Invention

Meanwhile, the above described conventional manufacturing methods have a problem that the number of processes is increased since a first press process for molding a base material and a second press process for causing a surface material to adhere thereto and a problem that, for example, a hot melt film for bonding the surface material with the base material hardens and therefore the hardened hot melt film has to be removed in order to cover the edge of the base material by the surface material.

Therefore, it is an object of the present invention to provide a manufacturing method of a vehicle molded ceiling capable of performing a covering treatment of an edge of a molded ceiling with a small number of processes and improving productivity without generating above described problems.

### Means for Solving the Problems

A method of manufacturing a vehicle molded ceiling according to claim 1 is a method of manufacturing the molded ceiling by setting a base material together with a surface material in mold dies in which molding surfaces are formed to have desired curved surfaces and performing heating/pressurizing so as to bond the base material with the surface material, the method is characterized by interposing a non-woven cloth layer, which facilitates peeling off the base material from the surface material even after molding, between the base material and the surface material in advance, making an incision in the base material from a rear side of the molded ceiling, peeling off merely an end material of the base material from the surface material by the non-woven cloth layer, applying an adhesive agent to the part from which the end material of the surface material is peeled off, winding the surface material around an edge of the base material, and causing the surface material to be bonded with the edge, so as to cover the edge by the surface material.

The method of manufacturing a vehicle molded ceiling according to claim 2 is a method of manufacturing the molded ceiling by setting a base material together with a surface material in mold dies in which molding surfaces are formed to have desired curved surfaces and performing heating/pressurizing so as to bond the base material with the surface material, the method characterized by including attaching a backing material having anon-woven cloth layer, which facilitates peeling off the surface material from the base material even after molding, to a rear surface of the surface material in advance, making an incision in the base material from a rear side of the molded ceiling, peeling off merely an end material of the base material from the surface material by the non-woven cloth layer, applying an adhesive agent to the part from which the end material of the surface material is peeled off, winding the surface material around an edge of the base material, and causing the surface material to be bonded with the edge, so as to cover the edge by the surface material.

The manufacturing method of the vehicle molded ceiling according to claim 3 is characterized in that the surface material comprises an urethane foam sheet attached to a rear surface of a textile, and adhesive agent non-permeative paper is attached to a rear surface of the urethane foam sheet with interposition of the non-woven cloth layer.

The manufacturing method of the vehicle molded ceiling according to claim 4 is characterized in that the surface material comprises a textile, an urethane foam sheet, and adhesive agent non-permeative paper having a non-woven cloth layer attached to each other by a flame laminate technique.

### EFFECTS OF THE INVENTION

The end material can be readily peeled off by separating, by the non-woven cloth layer, the end material generated by making an incision in the base material after molding the molded ceiling. Therefore, edge treatment can be readily performed. Moreover, productivity is improved because of the synergetic effect of the reduced number of required processes.

### BRIEF DESCRIPTION OF DRAWINGS

FIG. 1 is a vertical cross sectional view of a base material and a surface material of a vehicle molded ceiling according to the present invention;

FIG. 2 is a schematic diagram of a flame laminate technique for manufacturing the surface material of the vehicle molded ceiling according to the present invention;

FIG. 3 is an enlarged vertical cross sectional view of a backing material of the vehicle molded ceiling according to the present invention;

FIG. 4 is a vertical cross sectional view of molding dies showing a manufacturing method of the vehicle molded ceiling according to the present invention;

FIG. 5 is a perspective view of the vehicle molded ceiling according to the present invention;

FIG. 6 is a vertical cross sectional view in which an incision is made in a main part of the vehicle molded ceiling according to the present invention;

FIG. 7 is a vertical cross sectional view in which an end material of the main part of the vehicle molded ceiling according to the present invention is peeled off; and

FIG. 8 is a vertical cross sectional view of the main part of the vehicle molded ceiling according to the present invention.

### DESCRIPTION OF REFERENCE NUMERALS

1 BASE MATERIAL
1a END MATERIAL
7 SURFACE MATERIAL
8 TEXTILE
9 URETHANE FOAM SHEET
10 BACKING MATERIAL
11 PAPER
12 NON-WOVEN CLOTH LAYER
18, 19 MOLDING DIES
20 MOLDED CEILING
21 CUTTER

### BEST MODE FOR CARRYING OUT THE INVENTION

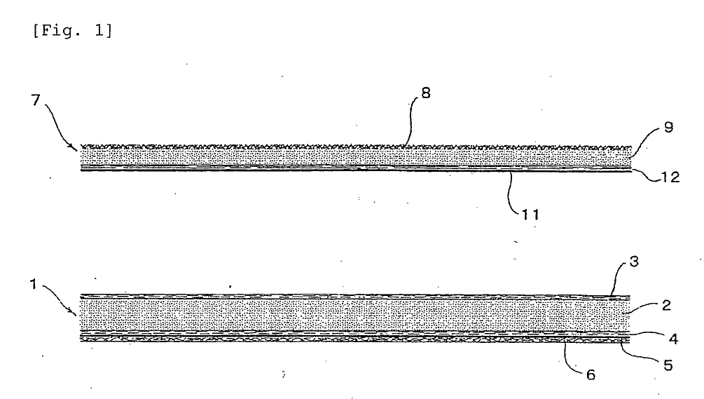

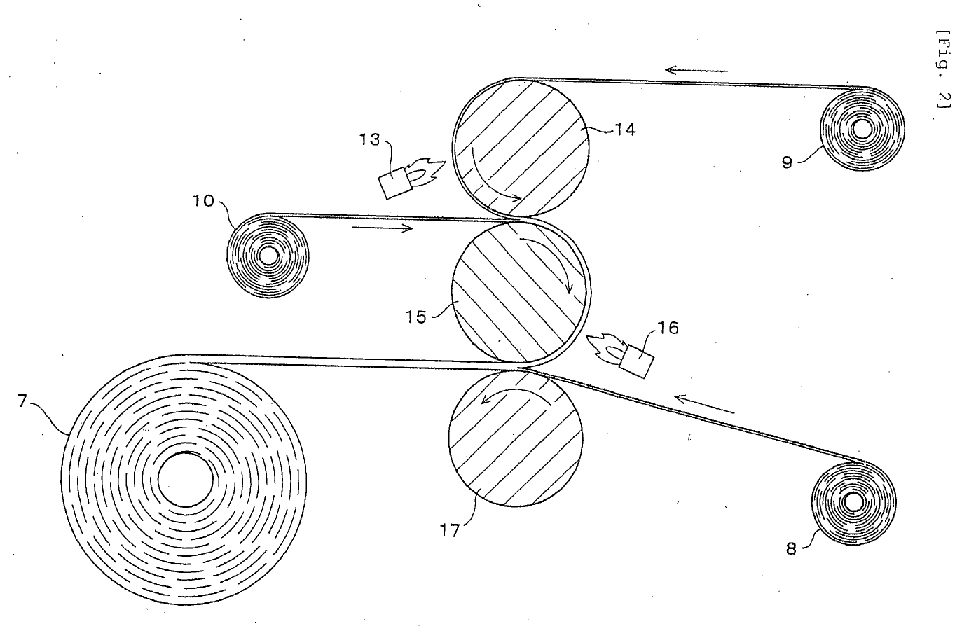

Next, an embodiment of the present invention will be described with drawings. As shown in FIG. 1, a base material 1 is formed by applying a thermosetting adhesive agent to both surfaces of a core material 2 composed of semi-hard urethane foam, stacking glass fiber mats 3 and 4 thereon, and stacking a back material 6 composed of a PET resin fiber non-woven cloth with interposition of a non-ventilative film 5 on the rear surface thereof. A surface material 7 is manufactured by a flame laminate technique shown in FIG. 2, and, in the drawing, reference numeral 8 is a textile such as a fabric wound like a roll, reference numeral 9 is a urethane foam sheet wound like a roll, and reference numeral 10 is a backing material wound like a roll. As shown in FIG. 3 in an enlarged manner, the backing material 10 is formed by providing a non-woven cloth layer 12, which is formed by interlacing PET resin fibers by a known spun lace method, on one surface of an adhesive agent non-permeative paper 11. In the flame laminate technique, one surface of the urethane foam sheet 9 is roasted and melted by flame of a gas burner 13, the non-woven cloth layer 12 side of the backing material 10 is polymerized therewith and caused to pass through the part between rolls 14 and 15, the other surface of the urethane foam sheet 9 is roasted and melted by the flame of a gas burner 16 so as to polymerize it with the textile 8, and it is caused to pass through the part between rolls 15 and 17, thereby winding like a roll and manufacturing the surface material 7 having the cross sectional structure shown in FIG. 1. Note that the paper 11 having a weight per area of 5 to 200 g/m2 (preferably, 25 g/m2) can be used. The non-woven fabric cloth layer 12 having a weight per area of 5 to 200 g/m2 (preferably, 40 g/m2) can be used.

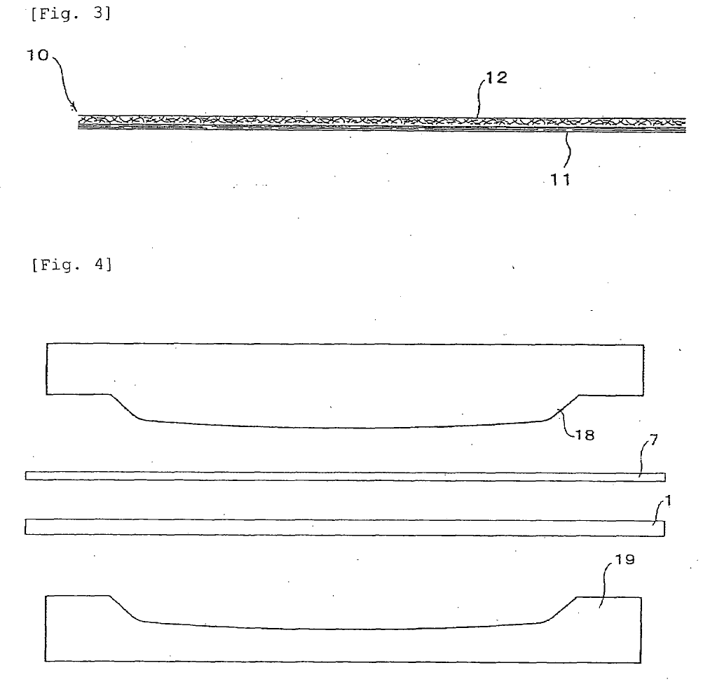

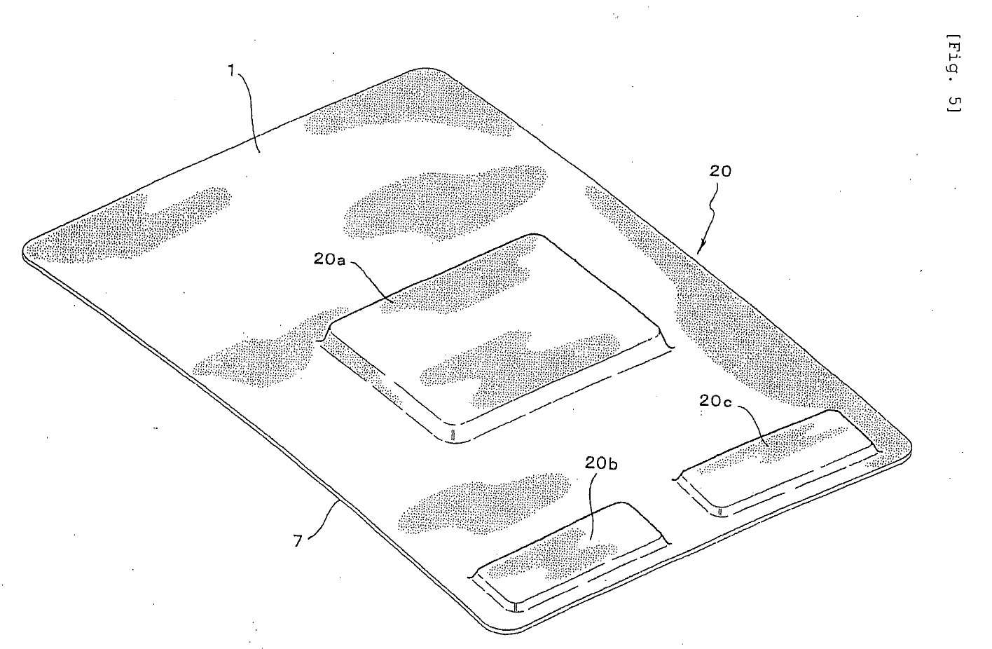

Then, as shown in FIG. 4, the base material is set together with the surface material 7 between molding dies 18 and 19 having molding surfaces formed to have desired curved surfaces, and heated/pressurized, thereby melting and permeating the thermo-setting adhesive agent between the base material 1 and the surface material 7 and bonding the base material 1 with the surface material 7. In this process, the paper 11 prevents the thermosetting adhesive agent from permeating to the non-woven cloth layer 12 upon heating/pressurizing. Thus, a molded ceiling 20 having a desired three-dimensional curved surface as shown in FIG. 5 is obtained. FIG. 5 is a perspective view from the side of the base material 1 of the molded ceiling 20, wherein 20a represents a hill-like portion which is formed to slightly bulge toward the base material 1 side in order to form an opening portion for a sunroof, and 20b and 20c represent hill-like portions formed to slightly bulge toward the base material 1 side so that sun visors can be housed in the lower surfaces (interior side) thereof.

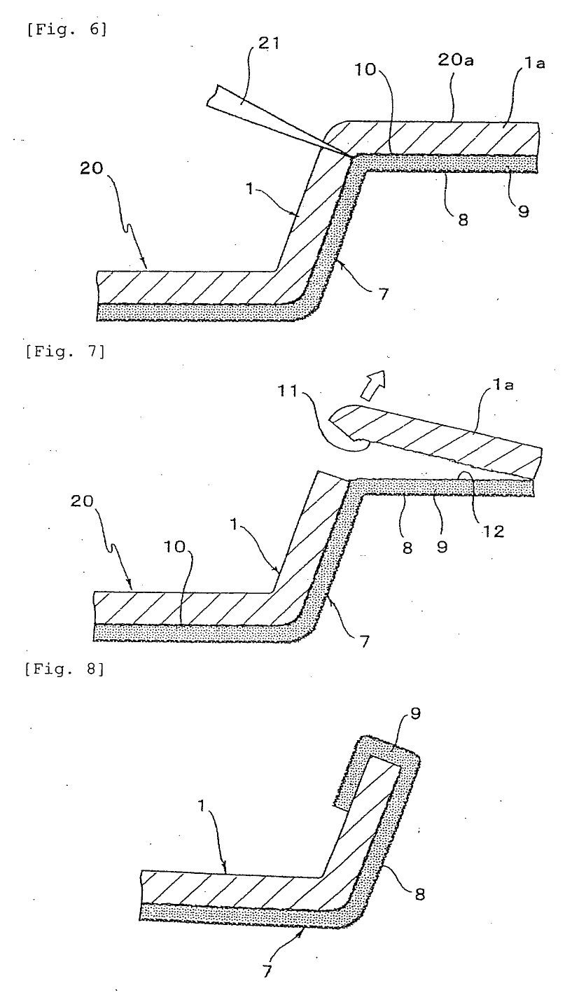

Then, as shown in FIG. 6, an incision is made in the hill-like portion 20a of the molded ceiling 20 by a cutter 21 from the base material 1 side, and a required opening portion such as a sunroof is formed in the base material 1. Then, merely an end material 1a generated by this incision is peeled off by the non-woven cloth layer 12 from the surface material 7 as shown in FIG. 7. In this process, since the adhesive agent is not permeated in the non-woven cloth layer 12, the non-woven cloth layer can be readily separated, the urethane foam sheet 9 is not strongly pulled and torn, and merely the end material 1a can be readily detached. Then, when an adhesive agent is applied to the urethane foam sheet 9, and an edge of the surface material 7 winds around an edge of the base material 1 and bonded therewith as shown in FIG. 8, the edge of the base material 1 can be covered by the surface material 7, thereby improving the appearance.

Note that, since the paper 11 is provided, the adhesive agent does not ooze to the surface material 7, and the appearance can be beautifully finished. Moreover, since the non-woven cloth layer 12 is provided, the non-woven cloth layer functions as a sound absorbing layer, and the molded ceiling 20 also has excellent sound absorbing ability.

Although an opening portion for a sunroof has been described in this embodiment, similar edge processing can be performed also for the rim of the molded ceiling 20, the rim of the sun visors, or inner edges of holes for attaching a map lamp, assisting grips, or the like.

As described above, in the present invention, imparting a desired curved surface to the base material by heating/pressurizing by the mold dies and adhering the surface material can be performed at the same time; therefore, required processes can be reduced, removal of the end material of the base material is facilitated since the base material and the surface material can be readily peeled off from each other by interposing the non-woven cloth layer in advance, edge processing is facilitated, and significant effects of improving the productivity of the molded ceiling can be obtained.

1. (canceled)

2. (canceled)

3. (canceled)

4. (canceled)

5. A manufacturing method of a vehicle molded ceiling, in which a surface material comprises an urethane foam sheet attached to a rear surface of a textile and adhesive agent non-permeative paper attached to a rear surface of the urethane foam sheet with interposition of a non-woven cloth layer, the molded ceiling is manufactured by setting a base material together with the surface material in mold dies in which molding surfaces are formed to have desired curved surfaces and performing heating/pressurizing so as to bond the base material with the surface material; the method including making an incision in the base material from a rear side of the molded ceiling, peeling off merely an end material of the base material from the surface material by the non-woven cloth layer, applying an adhesive agent to the part from which the end material of the surface material is peeled off, winding the surface material around an edge of the base material, and causing the surface material to be bonded with the edge, so as to cover the edge by the surface material.

6. The manufacturing method of the vehicle molded ceiling according to claim 5, wherein the surface material comprises a textile, an urethane foam sheet, and adhesive agent non-permeative paper having a non-woven cloth layer attached to each other by a flame laminate technique.
